(19) United States
(12) Patent Application Publication
(10) Pub. No.: US 2015/0233176 A1
(43) Pub. Date: Aug. 20, 2015

(54) SUPPORT DEVICE FOR PROTECTING WINDOW GLASS

(71) Applicant: Ho-Eon JEON, Tongyoung-si Gyeongsangnam-do (KR)

(72) Inventor: Ho-Eon Jeon, Tongyoung-si Gyeongsangnam-do (KR)

(21) Appl. No.: 14/434,424

(22) PCT Filed: Jul. 22, 2013
(86) PCT No.: PCT/KR2013/006546

§ 371 Date: Apr. 9, 2015

(30) Foreign Application Priority Data
Oct. 11, 2012 (KR) 10-2012-0113181

(51) Int. Cl. E06B 7/28

(52) U.S. Cl. CPC E06B 7/28; E06B 2009/005

(57) ABSTRACT

Disclosed a support device for protecting window glass. The support device for protecting window glass comprises: a main body for supporting the window glass; a plurality of extension belts which extend radially from the main body, each with a first end detachably fastened thereto; and suction plates constituted at each of the other ends of the extension belts. The main body for supporting the window glass has: a first member which is height adjustable and to which the ends of each of the plurality of extension belts are fastened; and a suction plate of a second member which is provided on a surface on one side of the first member, and is constituted so as to make contact with the window glass.

### TECHNICAL FIELD

The present invention relates to a support device for protecting window glass which can prevent the window glass from being bent and thus broken by pressure of typhoon or strong wind.

More particularly, the present invention relates to a support device for protecting window glass which can be easily detachably attached to an inner surface of the window glass and can prevent the window glass from being broken by evenly distributing the wind pressure exerted to the window glass.

### BACKGROUND ART

In general, there are many cases that wide whole glass is used in a living room of houses, tail buildings, apartments etc. in order to secure view of the outside or clear sight.

In the case of installing the window by using the wide whole glass, it is advantageous for securing the view or sight; however, there is a disadvantage that the glass can be easily broken by wind pressure of strong wind, storm, typhoon and the like. In particular, the window of buildings or tall buildings located in seashore is easily exposed to the strong wind, and breaking of the window due to exposure to the strong wind may lead to a severe damage.

For solving the above problem, Korean Registered Utility Model No.20-398173 (cited reference 1) discloses a supporter for protecting glass in which suction plates are disposed at constant intervals on one surface of a support plate having a predetermined length along a longitudinal direction of the support plate.

The supporter for protecting glass of the cited reference 1 can serve, to some extent, to protect the glass of the window from the strong window, but a length of the supporter has to be suited to a size of the window; therefore, there is a disadvantage that supporters each having a different length have to foe prepared for different sizes of the windows.

Furthermore, there is another disadvantage that the wind pressure cannot be evenly distributed since the supporter is supported on a central portion of the window in a “l”-shaped manner. In addition, there is yet another disadvantage that it is inconvenient to store the supporter after use thereof. Document of prior art Patent document (Patent document 0001) cited reference 1: Korean Registered Utility Model No.20-398173

### SUMMARY OF THE INVENTION

### Technical Problems

The present invention was devised in order to solve the above-mentioned problems, and an object of the present invention, therefore, is to provide a support device for protecting window glass which can be easily detachably attached to any window glass to support the window glass regardless of the size of the window glass.

Another object of the present invention is to provide a support device for protecting window glass which can evenly distribute the wind pressure exerted to the window glass.

Yet another object of the present invention is to provide a support device for protecting window glass whose volume can be reduced for convenience of storage after use of the support device.

Yet another object of the present invention is to provide a support device for protecting window glass which allows easy adjustment of tension.

### Solution to the Problem

For achieving the above-mentioned objects, a support device for protecting window glass of the present invention is characterized in that the support device includes a main body for supporting window glass; a plurality of extension belts which extend radially from the main body for supporting window glass, each with one end detachably coupled to the main body; and fixing units provided at the other ends of the respective extension belts.

Furthermore, the support device for protecting window glass is characterized in that the main body for supporting window glass includes a first member to which each of the plurality of extension belts is radially coupled at its one end; and a second member which is fixed to one side of the first member and configured so as to make contact with the window glass.

Furthermore, the support device for protecting window glass is characterized in that the second member is formed by a flexible member.

Furthermore, the support device for protecting window glass is characterized in that the first member includes a support plate, a height-adjusting unit which is disposed upright with its one end fixed to the support plate, and an extension belt-coupling unit which is fixed to an upper end of the height-adjusting unit, and is configured such that the one end of each of the extension belts is coupled with the extension belt-coupling unit.

Furthermore, the support device for protecting window glass is characterized in that a spring is interposed between the height-adjusting unit and the extension belt-coupling unit.

Furthermore, the support device for protecting window glass is characterized in that the fixing unit provided at the other end of each extension belt includes a ring or first suction means.

Furthermore, the support device for protecting window glass is characterized in that the second member includes a second suction means.

Furthermore, the support device for protecting window glass is characterized in that each of the first suction means and second suction means includes a suction plate and a lever for adhering the suction plate to a surface of the window glass.

Furthermore, the support device for protecting window glass is characterized in that the extension belt-coupling unit is provided with an extension belt tension gauge.

Furthermore, the support device for protecting window glass is characterized in that each of the extension belt is provided with a length-adjusting unit for the belt.

Furthermore, the support device for protecting window glass is characterized in that the height-adjusting unit is configured to be height-adjustable by screw-coupling at least two rods.

Furthermore, the support device for protecting window glass is characterized in that the support plate is provided with a pressure-sensing sensor capable of sensing a pressure exerted to the height-adjusting unit and with an indication device.

### EFFECTS OF THE INVENTION

The support device for protecting window glass of the present invention can support the window glass while evenly distributing a wind pressure exerted to the window glass by the fact that the support device includes a main body for supporting window glass; a plurality of extension belts which extend radially from the main body, each with one end detachably coupled to the main body; and first suction plate provided at the other ends of the respective extension belts, wherein the main body for supporting window glass includes a first member to which each of the plurality of extension belts is radially coupled at its one end and which is height-adjustable; and a second suction plate which is fixed to one side of the first member and configured so as to make contact with the window glass.

Furthermore, the support device for protecting window glass of the present invention can foe easily detachably attached to any window glass regardless of the size of the window glass and also can be easily stored after use.

Furthermore, angle of the extension belt can be adjusted by properly adjusting a height of the first member depending on the size of the window glass, whereby an effect of supporting the window glass can be maximized.

### BRIEF DESCRIPTION OF THE DRAWINGS

FIG. 1 is a three dimensional view showing a support device for protecting window glass of a first embodiment;

FIG. 2 is a top view showing an installed state of the support device for protecting window glass of the first embodiment;

FIG. 3 is a top view showing another installed state of the support device for protecting window glass of the first embodiment;

FIG. 4 is a cross-sectional view of a main body supporting window glass constituting the support device for protecting window glass of the first embodiment;

FIG. 5 is a cross-sectional view of a fixing unit constituting the support device for protecting window glass of the first embodiment;

FIG. 6 is a cross-sectional view of another example of a main body supporting window glass constituting the support device for protecting window glass of the first embodiment;

FIG. 7 is a three dimensional view showing a support device for protecting window glass of a second embodiment;

FIG. 8 is a cross-sectional view of a main body supporting window glass constituting the support device for protecting window glass of the second embodiment; and

FIG. 9 is a top view showing an installed state of the support device for protecting window glass of the second embodiment.

### BEST MODES FOR CARRYING OUT THE INVENTION

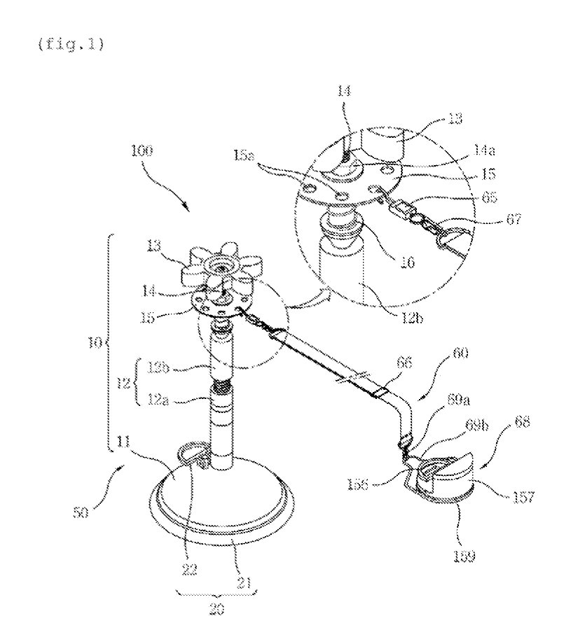

Hereinafter, detailed description will be made of technical construction and operational effects of a support device for protecting window glass of the present invention with reference to FIGS. 1 to 9.

### First Embodiment

The first embodiment will be mainly described with reference to FIGS. 1 to 6.

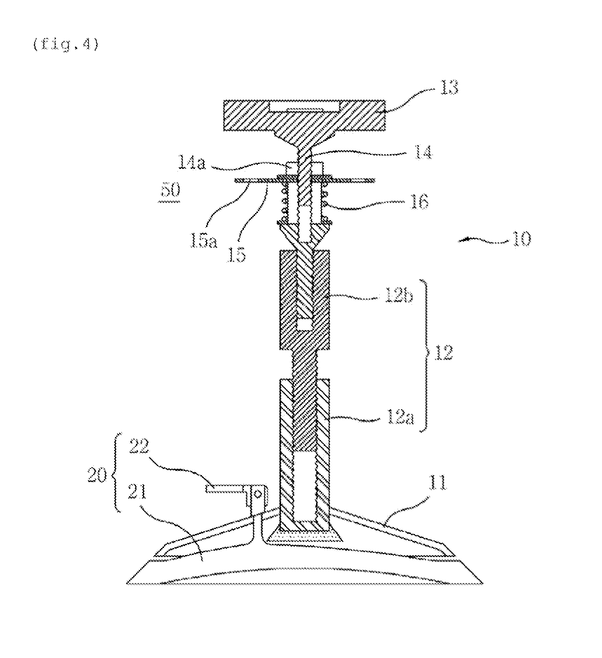

The support device (100) for protecting window glass of the first embodiment includes a main body (50) for supporting window glass and extension belts (60) which are radially coupled to the main body for supporting window glass, as shown in FIGS. 1 and 4.

The main body (50) for supporting window glass includes a first member (10) to which the extension belts are coupled, and a second member (20) which is fixed to one side of the first member and configured so as to make contact with the window glass.

The first member (10) includes a support plate (11), a height-adjusting unit (12) which is disposed upright with its one end fixed to the support plate, and an extension belt-coupling unit (15) which is fixed to an upper end of the height-adjusting unit. The height-adjusting unit (12) includes two rods (12a, 12b) which are linearly screw-connected with each other, and a shaft (14) having a rotation handle (13) is fitted and coupled into an upper end of the rod (12).

The extension belt-coupling unit (15) consists of a disc, and in an edge portion of the disc a plurality of holes (15a) are formed at constant intervals along an outer circumferential surface of the disc. The shaft (14) is fitted through a central portion of the extension belt-coupling unit (15). An upper surface of the extension belt-coupling unit (15) is caught and supported by a step protrusion (14a) formed on the shaft (14), and a lower surface of the extension belt-coupling unit is elastically supported by a spring (16) of which one end is supported by the rod (12b).

One end of each extension belt (60) may be directly connected to corresponding hole (15a) of the extension belt-coupling unit, or the one end of each extension belt (60) may be connected to the corresponding hole with an extension belt tension gauge (65) interposed therebetween which indicates the tension of the extension belt (60), as shown in FIG. 1.

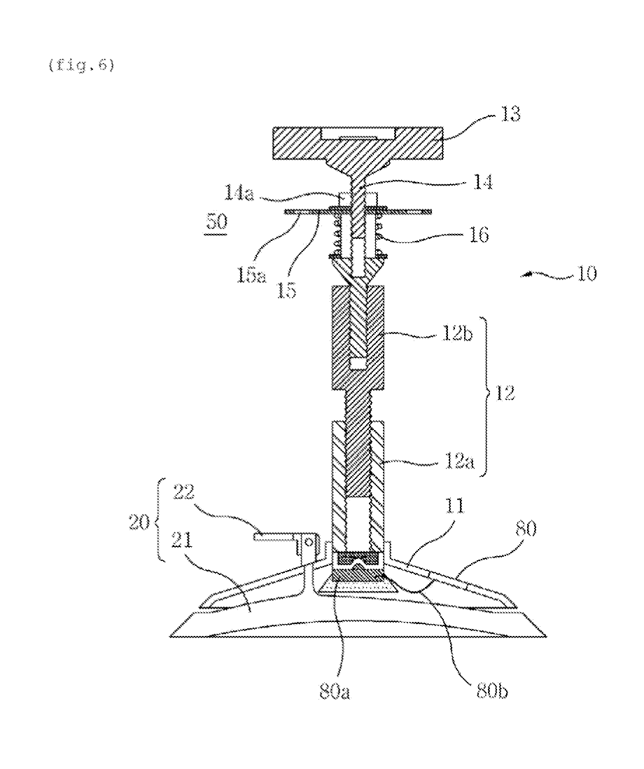

Although FIG. 1 exemplarily illustrates a structure where the extension belt tension gauge (65) is disposed for each extension belt, the preset invention is not limited to such a structure; the support plate (11) may be provided with a pressure-sensing sensor (80a) disposed on the support plate (11) to sense a pressure exerted by a lower end of the rod (12a) and with an indication device (80) for indicating the pressure sensed by the pressure-sensing sensor (80a) by a numerical value, instead of the tension gauge (65), as shown in FIG. 6. A sensed signal is transmitted from the pressure-sensing sensor (80a) to the indication device (80) through a wire (80b). In the case of the structure where the pressure-sensing sensor (80a) is disposed at the support plate (11), the pressure-sensing sensor has to be coupled with a slight play without departing from the support plate so that the pressure of the lower end of the rod (12a) fixed to the support plate (11) is intactly transmitted to the pressure-sensing sensor (80a).

When the pressure-sensing sensor (80a) is disposed on the support plate (11), the tension gauge (65) does not need to be disposed for each extension belt, and the whole pressure exerted to the main body (50) for supporting window glass can be easily measured by one pressure-sensing sensor (80a).

In the case of the main body (50) for supporting window glass configured as above, a distance between the rod (12a) and rod (12b) can be decreased or increased to properly adjust a length of the height-adjusting unit (12) by clockwise or counter-clockwise turning of the rotation handle (13) fixed to the rod (12b) with the shaft (14) interposed therebetween.

Meanwhile, the second member (20) fixed to the support plate (11) of the first member (11) and configured so as to make contact with the glass window constitutes suction means and includes a suction plate (21) and a lever (22) for adhering the suction plate (21) to a surface of the window glass.

The suction plate (21) is formed by rubber or silicone material provided on a lower surface of the support plate (11) having funnel-like appearance. If a central portion of the suction plate (21) is pulled toward the support plate (11) in an air-tight condition by the use of the lever (22) fixed to the support plate (11), a sealed space of low pressure is created between the surface of the glass contacting with the suction plate (21) and the suction plate and thus the suction plate (21) is strongly brought into close contact with the surface of the glass and thus fixed thereto. The suction means including the suction plate (21) and the lever (22) may be embodied by the use of already-known techniques.

Furthermore, each extension belt (60) is provided with a length-adjusting unit (66) for adjusting a length of the extension belt. A connection ring (67) is coupled with one end of the extension belt connected to the extension belt-coupling unit (15) via the extension belt tension gauge (65), and a fixing unit (68) is coupled with the other end of the extension belt.

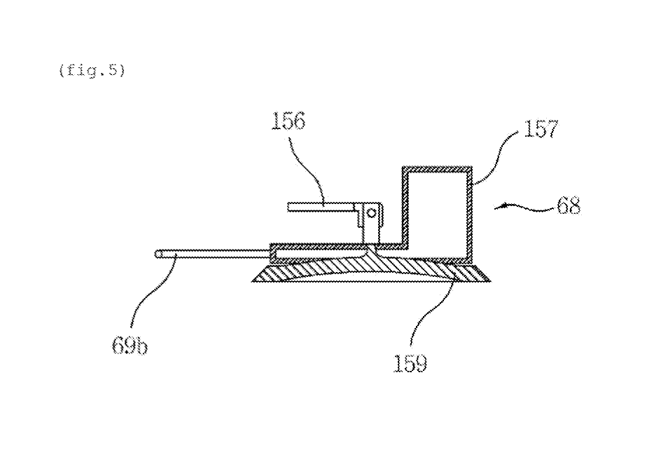

The fixing unit (68) includes a suction plate (159) constituting suction means, a support body (157) to which the suction plate is fixed, and a lever (156) which is fixed to the support body and configured to enable a central portion of the suction plate (159) to be pulled toward the support body (157), as shown in FIG. 5.

The fixing unit (68) and the other end of the extension belt (60) are connected through connection rings (69a, 69b).

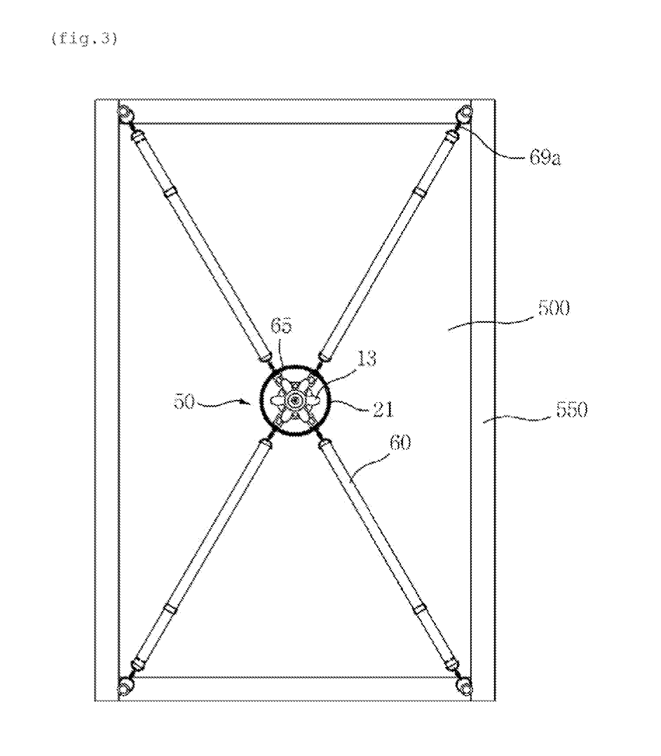

The fixing unit (68) may be configured by the use of the same technique as the suction means constituting the second member (20) or of a general ring as shown in FIG. 3.

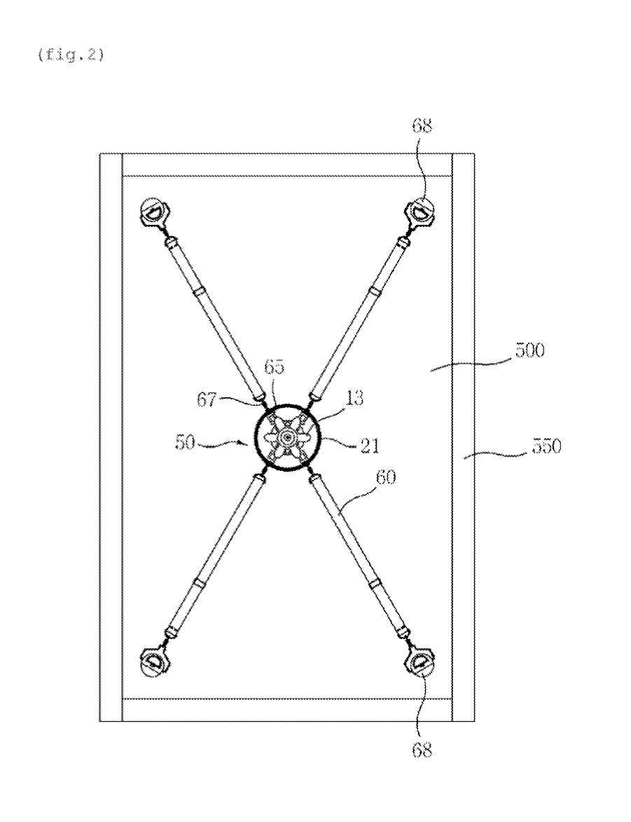

Referring to FIGS. 1 and 2, description will be made of a process of installing the support device (100) for protecting window glass of the present invention configured as above on the window glass.

First, a plurality of the extension belts (60) are coupled to the holes (15a) of the extension belt-coupling unit so that the extension belts can be radially disposed, and the height-adjusting unit (12) is adjusted in view of the size of the window glass.

After previously adjusting the support device (100) for protecting window glass as described above, the suction plate (21) is brought into contact with a central portion of the window glass (500) inside a living room and subsequently the suction plate (21) is compressed against and fixed to the window glass (500) by the use of the lever (22).

Next, the suction plate (159) of the fixing unit (68) provided at the other end of each extension belt (60) is compressed against and fixed to a corner portion of the window glass (500) inside the living room, and thereafter, the extension belt (60) is tightly pulled and fixed by the use of the length-adjusting unit (66) for the belt. In such a state, the height-adjusting unit (12) is finely adjusted again so that the extension belt has a suitable tension.

By a proper adjustment of the tension of the extension belt (60), the wind pressure concentrated to the central portion of the window can be distributed toward edges of the window, and thus the window glass is protected.

In a case where the fixing unit (68) is configured by the general ring, not by the suction plate, the ring may be fixedly suspended on a window frame (550) of the window glass (500) or wall inside the living room, as shown in FIG. 3.

### Second Embodiment

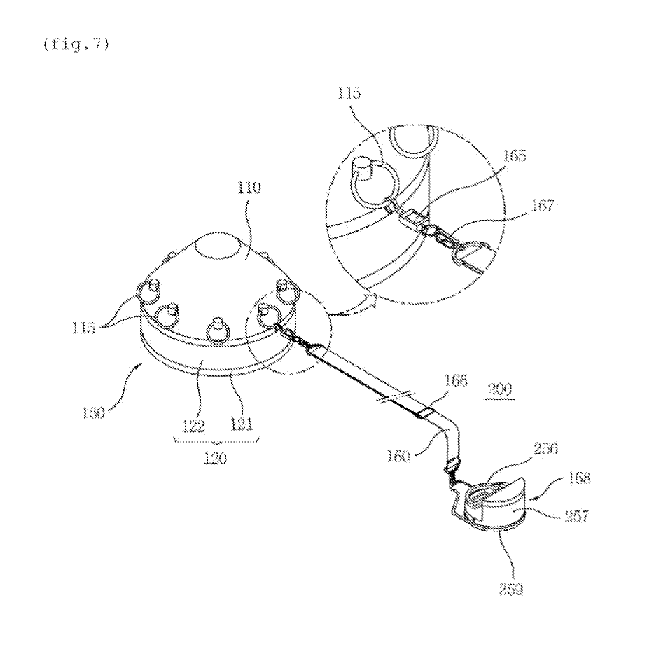

The second embodiment will be mainly described with reference to FIGS. 7 to 9.

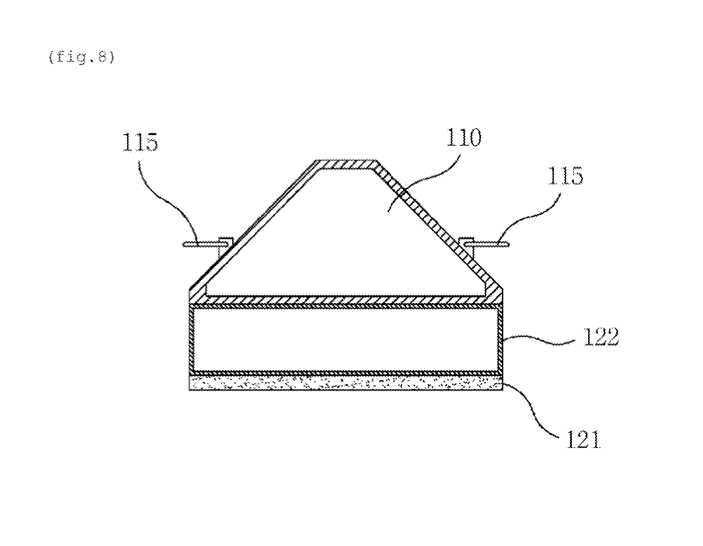

A support device (200) for protecting window glass of the second embodiment includes a main body (150) for supporting window glass and extension belts (160) which are radially coupled to the main body for supporting window glass, as shown in FIGS. 7 and 8. The main body (150) for supporting window glass includes a first member (110) to which the extension belts are coupled, and a second member (120) which is fixed to one side of the first member and configured so as to make contact with the window glass.

An edge of the first member (110) is provided with extension belt-coupling units (115) each including a ring. The extension belt-coupling units (115) are circularly disposed at constant intervals. One end of each extension belt (160) is connected to corresponding extension belt-coupling unit (115) with an extension belt tension gauge (165) interposed therebetween which indicates the tension of the extension belt (160).

The second member (120) fixed to the first member and configured so as to make contact with the window glass is formed by flexible member.

The second member (120) is formed by the flexible member includes an air pocket (122) fixed, to the first member (110) and a silicone material (121) fixed to the air pocket.

The second member (120) may be formed by the suction means illustrated in FIG. 1 instead of the flexible member.

Meanwhile, each extension belt (160) is provided with a length-adjusting unit (166) for adjusting the length of the extension belt. A connection ring (167) is coupled with one end of the extension belt connected to the extension belt-coupling unit (115) via the extension belt tension gauge (165), and a fixing unit (168) is coupled with the other end of the extension belt.

The fixing unit (168) includes a suction plate (259), a support body (257) to which the suction plate is fixed, and a lever (256) which is fixed to the support body and configured to enable pulling a central portion of the suction plate (259) toward the support body (257).

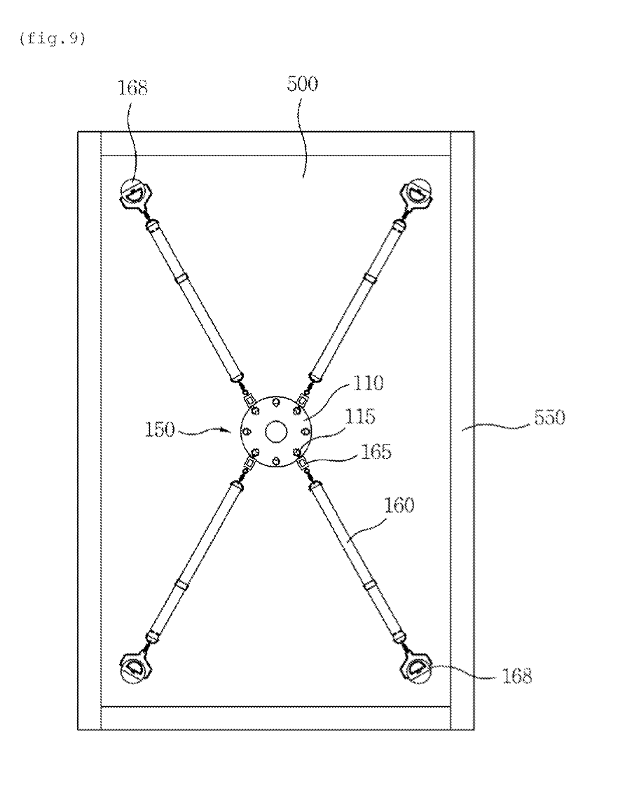

Referring to FIGS. 7 and 9, description will be made of a process of installing the support device (200) for protecting window glass of the present invention configured as above on the window glass.

First, a plurality of the extension belts (160) are coupled to the extension belt-coupling units (115) so that the extension belts can be radially disposed.

Next, the suction plate (259) of the fixing unit (168) provided at the other end of each extension belt (160) is compressed against and fixed to a corner portion of the window glass (500) inside the living room by the use of the lever (256).

Subsequently, the length and tension of each extension belt are properly adjusted by the use of the length-adjusting unit (166) for the belt so that the silicone material (121) constituting the first member is positioned at the central portion of the window glass inside the living room.

The support devices for protecting window glass according to the first and second embodiments as described above are not limited to the drawings attached to the specification and the subject matter described in the detailed description section of the specification and may be variously modified without departing from the objects and claims of the present invention.

### LIST OF REFERENCE NUMERALS

10, 110: first member

11: support plate

12: height-adjusting unit

12a, 12b: rod

13: rotation handle

14: shaft

14a: step protrusion

15, 115: extension belt-coupling unit

15a: hole

16: spring

20, 120: second member

21, 159, 259: suction plate

22, 156, 256: lever

50, 150: main body for supporting window glass

60, 160: extension belt

65, 165: extension belt tension gauge

66, 166: length-adjusting unit

67, 69a, 69b, 167: connection ring

68, 168: fixing unit

80: indication device

80a: pressure-sensing sensor

80b: wire

100, 200: support device for protecting window glass

121: silicone material

122: air pocket

157, 257: support body

500: window glass

550: window frame

What is claimed is:

1. A support device for protecting window glass, comprising:
a main body for supporting window glass;
a plurality of extension belts which extend radially from the main body for supporting window glass, each with one end detachably coupled to the main body; and
fixing units provided at the other ends of the respective extension belts.

2. The support device for protecting window glass according to claim 1, wherein the main body for supporting window glass comprises a first member to which each of the plurality of extension belts is radially coupled at its one end; and a second member which is fixed to one side of the first member and configured so as to make contact with the window glass.

3. The support device for protecting window glass according to claim 2, wherein the fixing unit provided at the other end of each extension belt comprises a ring or first suction means.

4. The support device for protecting window glass according to claim 3, wherein the second member comprises a second suction means.

5. The support device for protecting window glass according to claim 2, wherein the second member is formed by a flexible member.

6. The support device for protecting window glass according to claim 4, wherein the first member comprises a support plate, a height-adjusting unit which is disposed upright with its one end fixed to the support plate, and an extension belt-coupling unit which is fixed to an upper end of the height-adjusting unit, and is configured such that the one end of each of the extension belts is coupled with the extension belt-coupling unit.

7. The support device for protecting window glass according to claim 4, wherein each of the first suction means and second suction means comprises a suction plate and a lever for adhering the suction plate to a surface of the window glass.

8. The support device for protecting window glass according to claim 4, wherein each of the extension belt is provided with a length-adjusting unit for the belt.

9. The support device for protecting window glass according to claim 6, wherein the extension belt-coupling unit is provided with an extension belt tension gauge.

10. The support device for protecting window glass according to claim 6, wherein the height-adjusting unit is configured to be height-adjustable by screw-coupling at least two rods.

11. The support device for protecting window glass according to claim 6, wherein a spring is interposed between the height-adjusting unit and the extension belt-coupling unit.

12. The support device for protecting window glass according to claim 6, wherein the support plate is provided with a pressure-sensing sensor capable of sensing a pressure exerted to the height-adjusting unit.
